(19) United States
(12) Patent Application Publication
(10) Pub. No.: US 2003/0070282 A1
(43) Pub. Date: Apr. 17, 2003

(54) Ultra-miniature magnetic device

(75) Inventors: Fred C. Hiatt, Lakeville, MN (US); John E. DeCramer, Marshall, MN (US); Robert T. Fayfield, St. Louis Park, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: BH Electronics, Inc.

(21) Appl. No.: 10/255,116

(22) Filed: Sep. 25, 2002

Related U.S. Application Data
(63) Continuation-in-part of application No. 09/530,371, filed on Apr. 27, 2000, now abandoned.

(51) Int. Cl. H01F 7/06; H01F 17/04

(52) U.S. Cl. 29/602.1; 29/606; 336/221; 336/213

(57) ABSTRACT

An ultra-miniature magnetic device generally comprises a conductive winding and a magnetic core. The magnetic core is of an elongate rectangular or oval shape having two elongate sections and two short sections having an easy axis of magnetization on all sections. In an example embodiment, a section of a magnetic core is formed by plating an exposed portion of a substrate that is covered by a photoresist mask. During plating the substrate is subjected to an external magnetic field to provide an easy axis. Another section of the magnetic core is then formed by masking the plated portion and plating the exposed portion of the substrate to form a magnetic core. In a related embodiment, a non-magnetic metallic material layer is interleaved between two magnetic layers to form a high inductance magnetic core.

### RELATED APPLICATIONS

The present application is a continuation-in-part of the U.S. application filed on Apr. 27, 2000 having Ser. No. 09/530,371, that claims priority from PCT Application filed on Jul. 23, 1999 having Serial No. PCT/US99/16446 which claims priority from U.S. Provisional Application having Serial No. 60/093,824, filed Jul. 23, 1998, which are hereby incorporated by reference in their entirety.

### FIELD OF THE INVENTION

The present invention relates to transformers and inductors fabricated with high volume semiconductor technology production processes.

### BACKGROUND OF THE INVENTION

High frequency magnetic components are used in many applications including computer data transmission, cable TV video, and interactive CATV, among others. These applications generally require transformers and inductors that operate efficiently in the frequency range from 5 MHz to 1 GHz and beyond. However, a problem with conventional magnetic components is that they are large and bulky in comparison to the circuits in which they operate.

Further, manufacturing techniques of magnetic components typically involve machine winding techniques for large-cored magnetic components and hand winding for small-cored magnetic components. As operating frequencies increase, transformers and inductors typically decrease in size, having finer electrical wire and smaller magnetic cores; wire sizes of 42 gauge (0.075 mm in diameter) and core diameters of 2.5 mm are common. Machine assembly with these small cores is impractical. As such, hand winding of wire onto the magnetic core, hand assembly of the wound core on the mounting header, and hand soldering of the wire to header connectors is required. Because all of these operations require high levels of manual dexterity and are very time consuming, it is not uncommon for labor costs to represent 60-70% of the total product cost.

Some research has been performed in the area of microtransformers and micromachining using electroplating techniques to obtain very thick conductors and ferrite materials. However, since this research generally applies to sensors and higher power magnetic devices operating in lower frequency ranges, the research is generally not applicable or viable for high frequency applications.

In view of the above, there is a need for an innovative approach for manufacturing miniature high frequency inductors and transformers. The manufacturing approach preferably is automated so as to reduce manufacturing costs as well as reduce the size of high frequency magnetic components.

### SUMMARY OF THE INVENTION

The needs described above are in large measure met by an ultra miniature magnetic device of the present invention. The ultra-miniature magnetic device generally comprises a conductive winding and a magnetic core. The conductive winding includes an upper conductor and a lower conductor. The magnetic core is of an elongate rectangular or oval shape having two elongate sections and two short sections. The lower conductor is preferably positioned below the elongate sections of the magnetic core while the upper conductor is preferably positioned above the elongate sections of the magnetic core. The lower and upper conductors are electrically connected by conducting vias resulting in a coil winding about the elongate sections. The short sections are preferably free of windings. The ultra-miniature magnetic device is preferably fabricated using high-volume, semi-conductor technology.

The coil windings may be a simple winding, a bifilar winding, or a multifilar winding. Further, the magnetic material may be subjected to an external magnetic field during fabrication to align the easy axis in a desired direction. The magnetic core may comprise a single layer of magnetic material or may comprise a number of layers of magnetic material, wherein each layer of magnetic material is separated by a dielectric material. The magnetic material may incorporate an air gap if suitable to the magnetic device application. Because of the generally rectangular or oval elongate shape of the magnetic core, it may be easily scaled in cross-sectional area to suit a specific magnetic device application. The magnetic device may be fabricated to operate at a range of frequencies from approximately 64 KHz to 2 GHz. The ultra miniature magnetic device may include center and offset taps.

A process of fabricating the ultra miniature magnetic device includes the steps of depositing the lower conductor atop a substrate, depositing the magnetic core atop the lower conductor, depositing the upper conductor atop the magnetic core, (with each layer separated by a dielectric layer) and electrically coupling the lower conductor to the upper conductor so as to configure the upper conductor and the lower conductor about at least one of the elongate sections of the magnetic core.

In one example embodiment, a method of fabricating a magnetic core includes forming a first photoresist layer over a substrate that includes at least two portions that expose the substrate and then plating the at least two exposed portions with a magnetic material while subjecting the plated material to an external magnetic field so as to form a first set of magnetic material layers. The magnetic field aligns an easy axis of magnetization in a direction parallel to a long axis of the first set of magnetic material layers. The method also includes removing the first photoresist mask and forming a second photoresist layer that masks the first set of magnetic layers and that includes at least two portions that expose the substrate and plating the at least two exposed portions with a magnetic material while subjecting the plated material to the external magnetic field so as to form a second set of magnetic material layers. The magnetic field aligns an easy axis of magnetization in a direction parallel to a long axis of the second set of magnetic material layers. The method further includes removing the second photoresist layer and exposing the magnetic core formed from the first and second set of magnetic layers surrounding a central aperture, wherein the magnetic core has an easy axis of magnetization which extends parallel to the long axis of the magnetic material layers.

The techniques used to deposit the conductors and magnetic core are preferably semi-conductor technology techniques including but not limited to: thin or thick film procedures, electroplating, vacuum deposition and etching processes—including PECVD, RF sputter deposition, reactive ion etching, ion milling, plasma etching, photo-lithographic processes and wet chemical etching.

### DESCRIPTION OF THE DRAWINGS

FIG. 1A is perspective view of an ultra-miniature magnetic device of the present invention.

FIG. 1B is an exploded view of detail B of FIG. 1A.

FIG. 2 provides a top view of a lower conductor; the result of a first stage of fabrication of ultra-miniature magnetic device of the present invention.

FIG. 3 is a cross-sectional view taken along line 3-3 of FIG. 2.

FIG. 4A provides a top view of a magnetic core; the result of a second stage of fabrication of ultra-miniature magnetic device of the present invention.

FIG. 4B provides a top view of a magnetic core incorporating a gap; the result of a second stage of fabrication of ultra-miniature magnetic device of the present invention.

FIG. 5A is a cross-sectional view taken along line 5-5 of FIG. 4A wherein the magnetic core comprises a single layer of magnetic core material.

FIG. 5B is a cross-sectional view taken along line 5-5 of FIG. 4A wherein the magnetic core comprises a plurality of layers of magnetic core material.

FIG. 6 provides a top view of conducting vias; the result of a third stage of fabrication of ultra-miniature magnetic device of the present invention.

FIG. 7 is a cross-sectional view taken along line 7-7 of FIG. 6.

FIG. 8 provides a top view of an upper conductor; the result of a fourth stage of fabrication of ultra-miniature magnetic device of the present invention.

FIG. 9 is a cross-sectional view taken along line 9-9 of FIG. 8.

FIG. 10A depicts one use of ultra-miniature magnetic device of the present invention, specifically an inductor.

FIG. 10B depicts one use of ultra-miniature magnetic device of the present invention, specifically a center-tapped inductor.

FIG. 10C depicts one use of ultra-miniature magnetic device of the present invention, specifically a transformer.

FIG. 10D depicts one use of ultra-miniature magnetic device of the present invention, specifically a transformer with a single primary coil and two secondary coils.

FIG. 11 depicts a circular configuration of ultra-miniature magnetic device of the present invention.

FIG. 12 depicts a square configuration of ultra-miniature magnetic device of the present invention.

FIG. 13 depicts an octagonal configuration of ultra-miniature magnetic device of the present invention.

FIG. 14 depicts an oval configuration of ultra-miniature magnetic device of the present invention.

FIG. 15A depicts the magnetic core subject to a magnetic field to orient the easy magnetic axis in the direction of the core.

FIG. 15B depicts the magnetic core subject to a magnetic field to orient the easy magnetic axis at 90° to the direction of the core.

FIG. 15C depicts the formation of a portion of a magnetic core arrangement in a plating bath while being subjected to a magnetic field.

FIG. 15D depicts the formation of another portion of the magnetic core arrangement in the plating bath while being subjected to a magnetic field.

FIG. 15E depicts the formation of another embodiment of the magnetic core arrangement.

FIG. 16 depicts a transformer model.

FIG. 17 is a plot of frequency vs. dB loss for a transformer designed with the ultra-miniature magnetic device of the present invention.

FIG. 18 is a plot of frequency vs. dB loss for an Ethernet transformer.

### DETAILED DESCRIPTION OF THE PREFERRED EMBODIMENTS

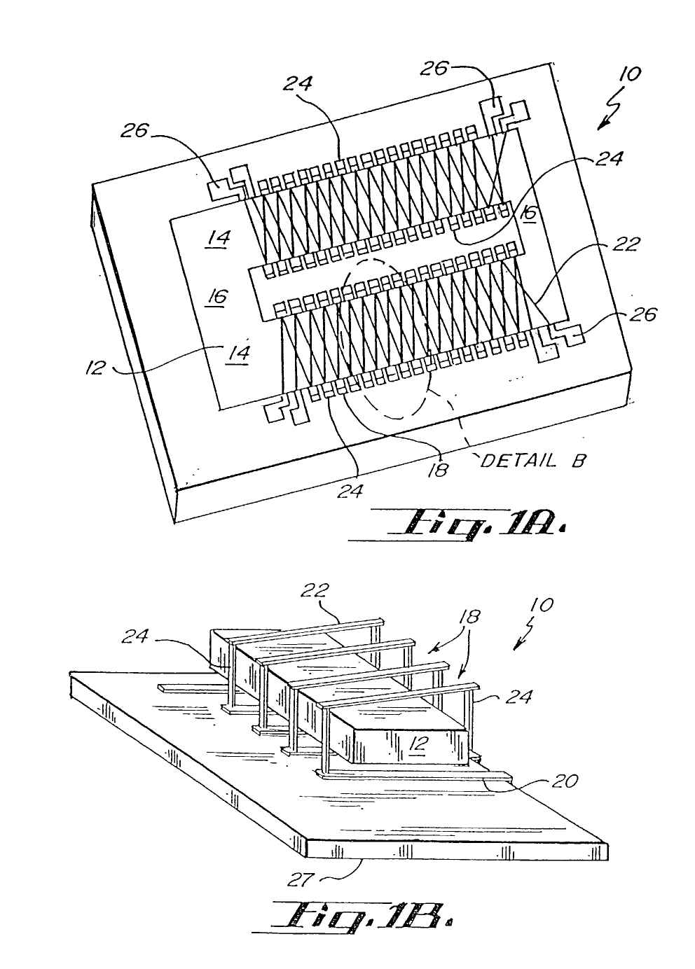

An ultra-miniature magnetic device 10 of the present invention is depicted in FIGS. 1A-B. As shown, device 10 generally includes a magnetic core 12, which is preferably in the configuration of an elongated rectangle or oval having two elongate sides 14 and two short sides 16, and a coil winding 18, which is preferably comprised of a lower conductor 20 and an upper conductor 22 connected by conducting vias 24. Bonding pads 26 are provided on coil winding 18 for connection to external circuitry. Ultra-miniature magnetic device 10 is preferably fabricated atop a silicon substrate 27 although other possible substrates such as glass, fiberglass, polyamide, ceramics and other insulating materials can be used.

I. Fabrication of Ultra-Miniature Magnetic Device

Device 10 is preferably fabricated using automated, semiconductor fabrication processes. In general, four main stages define the fabrication process: (1) Creation of lower conductor 20; (2) Addition of magnetic core 12; (3) Establishment of vias 24 and filling vias with conducting material; and (4) Addition of upper conductor 22.

I.A. Stage 1: Creation of Lower Conductor

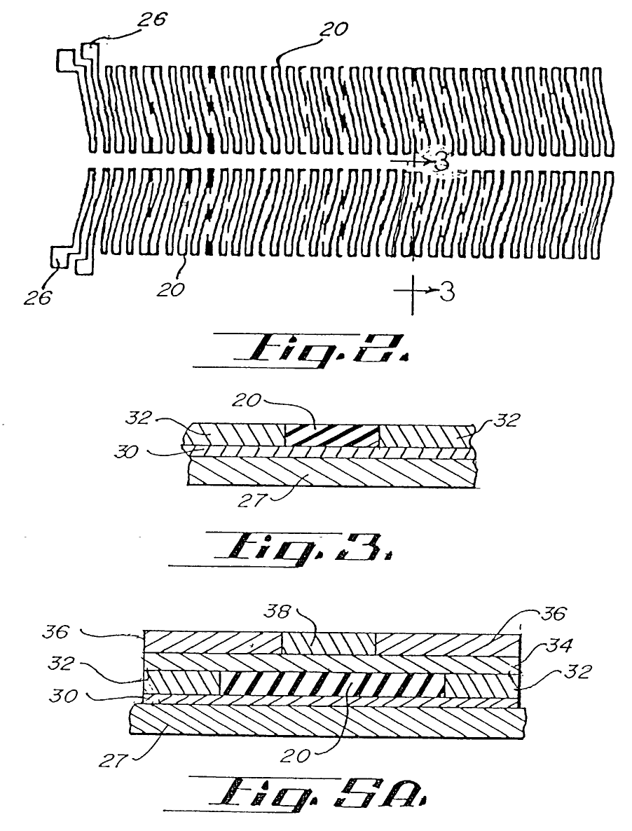

To create lower conductor 20, in reference to FIGS. 2 and 3, an insulating substrate, e.g., silicon wafer or other suitable material such as glass or ceramic, is preferably oxidized in a wet oxide (O₂) oxidation furnace to produce a layer of silicon dioxide (SiO₂) 30. Alternatively, an electroplating process may be used to create lower conductor 20. In the case of using electroplating process to form the conductors, a seed layer of titanium/copper/titanium or any suitable material is first deposited on the oxide surface to provide a conducting layer for the plating process. Next, an insulating layer 32 of polymer, or other suitable dielectric material, is deposited atop the silicon dioxide and seed layer. The thickness of insulating layer 32 is preferably equivalent to a predetermined thickness of lower conductor 20, with the predetermined thickness taking into account the resistance of the conducting material, as is described in further detail in Section II below.

With insulating layer 32 in place, a photoresist layer is deposited atop insulating layer 32 and defined with a lower conductor photomask. Insulating layer 32 is then defined by standard thin film techniques to create a trench for lower conductor 20. The conductor material is then preferably electroplated or sputter deposited. In the case of sputter deposition the photoresist layer is subsequently etched, or otherwise dissolved, to produce lower conductor 20 of coil winding 18. The conductor material is preferably copper, however, other suitable conductors, e.g., silver, aluminum, or gold may be used without departing from the spirit or scope of the invention.

FIG. 2 depicts a top view of partially completed device 10 after completion of stage 1. FIG. 3 depicts a cross-sectional view of partially completed device 10 after completion of stage 1; silicon dioxide and seed layer 30, insulating layer 32, and lower conductor 20 are depicted.

I.B. Stage 2: Addition of Magnetic Core

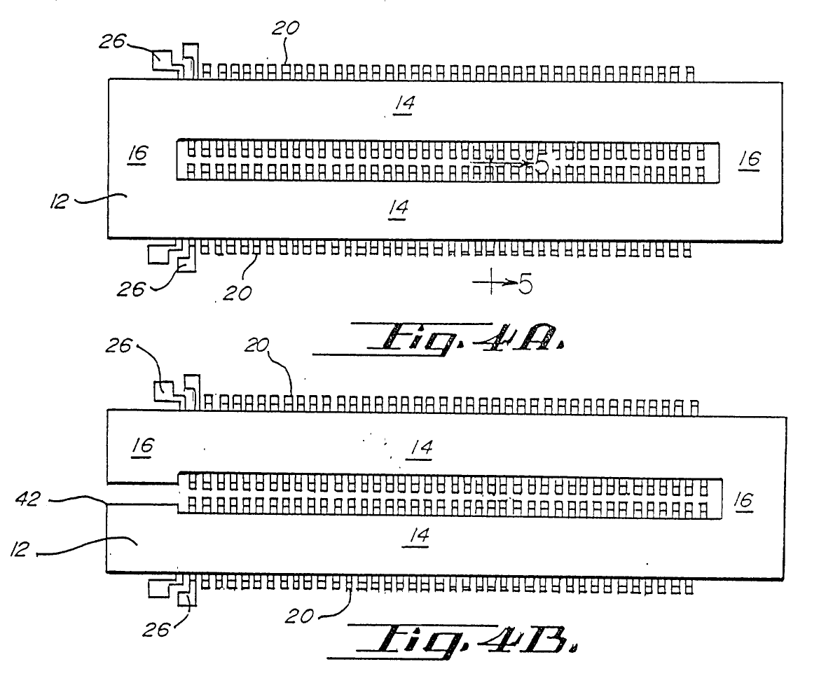

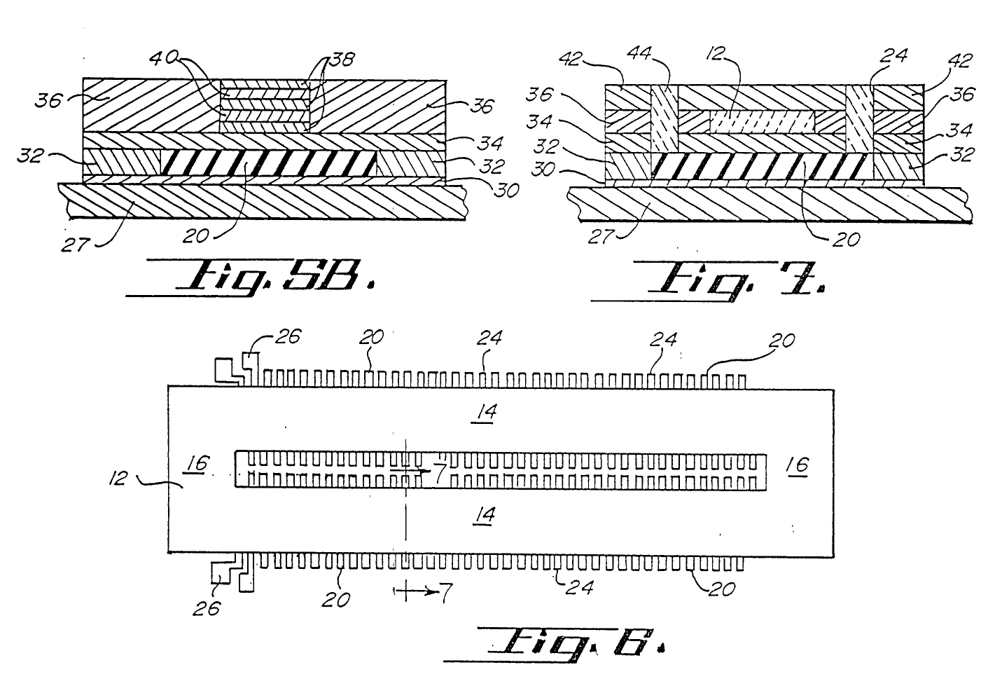

To add magnetic core 12 to lower conductor 20, with reference to FIGS. 4A-4B and 5A-5B, a dielectric layer 34 is preferably first deposited over conductor 20 to provide isolation between lower conductor 20 and magnetic core 12. The dielectric layer 34 is preferably an insulating polymer or silicon dioxide, however, other dielectrics may be used without departing from the spirit or scope of the invention. If it is desired to use an electroplating process to form the magnetic core, a seed layer of titanium/copper/titanium or other suitable conducting material is preferably first deposited on dielectric layer 34 to provide a conductive layer for the plating process. Next, an insulating layer 36 of polymer, or other suitable dielectric material, is deposited atop the dielectric and seed layer 34. The thickness of insulating layer 36 is preferably equivalent to a predetermined thickness of magnetic core 12, with the predetermined thickness of magnetic core 12 taking into account the permeability and the saturation level of the magnetic core material 38, as is described in further detail in Section II below.

With insulating layer 36 in place, a photoresist layer is deposited atop insulating layer 36 and defined using a magnetic core mask. Insulating layer 36 is then defined by standard thin film techniques to create a trench for formation of magnetic core 12. Magnetic core material 38 is then preferably electroplated or sputter deposited and, if desired, submitted to an external magnetic field to orient the grain structure, i.e., easy axis, of magnetic material in a desired direction. Magnetic core material 38 is preferably an iron/nickel/cobalt composition (15/65/20%), however, other magnetic core materials, e.g., nickel/iron (80/20%), may be used without departing from the spirit or scope of the invention. In the case of sputter deposition, the photoresist layer is etched, or otherwise dissolved, whereby unwanted magnetic core material 38 is removed.

While magnetic core 12 may comprise a single layer of magnetic core material 38, it may be desirable that magnetic core 12 comprise a plurality of very thin magnetic core material 38 layers, wherein each magnetic core material 38 layer is separated from the next by a dielectric layer 40. Using the plurality of magnetic core material 38 layers to form magnetic core 12 significantly lowers eddy current losses in magnetic core 12. In addition, each layer of the multilayer magnetic structure can have its easy axis oriented independently of the other layers.

Referring briefly to FIG. 5B, in a related embodiment, dielectric layers 40 are substitutable with a non-magnetic field conducting metallic material, such as copper (Cu), that substantially eliminates the generation of eddy currents. In this example embodiment, magnetic core 12 is formed from multiple layers of alternating magnetic core material layers 38 (as described within the specification; e.g., nickel/iron or iron/nickel/cobalt) and copper layers 40. Copper layers 40 are typically 1K to about 10K angstroms in thickness (can be about 1/100 the thickness of each magnetic core material layer). In this example, magnetic core layer 38 is formed over interlayer dielectric (ILD) 34 and then magnetic core layer 38 is plated with a copper layer (copper layer 40) when the substrate is electroplated in a copper bath. Another magnetic core layer 38 is then formed over another copper layer 40 and then the substrate is electroplated again in the copper bath to plate over magnetic core layer 38. These steps are performed sequentially until magnetic core 12 is of a desired thickness depending on the operating frequency of the device. The magnetic core material layers may also be formed by using a sputter (or other semiconductor) deposition process.

Copper layers 40 in the multiple layer magnetic core arrangement 12 effectively destroy the continuity of the magnetic core, thereby preventing the formation of eddy currents. The combination of the multiple magnetic core layers 38 increases the inductance of coil winding 18 (see FIG. 1B) more than just plating a thicker magnetic core. Magnetic cores are normally enlarged to increase inductance; however increasing core thickness increases the likelihood of generating eddy currents. Further, the approach of this example embodiment provides an advantage of eliminating the need for metallic seed layers after the deposition of each dielectric layer needed to form the magnetic core (magnetic core material layer adheres better to the metallic seed layer than the dielectric only). Copper layers 40 adhere to each magnetic core material layer 38 and each magnetic layer adheres to the copper layers. As a design consideration, the magnetic core material layer thickness is determined by the operating frequency of the device as the operating frequency affects the skin depth effect within the magnetic core layer. Where the thickness of the magnetic core layer exceeds the skin depth effect, eddy currents perpendicular to the magnetic field develop in the core to disrupt the magnetic field.

In another related embodiment, other metallic material layers can be used if they do not conduct magnetic fields, such as aluminum, gold and silver. These materials also provide the advantage of increasing manufacturing efficiency by reducing the number of different operations and tools necessary to manufacture the core. Magnetic core 12 can be manufactured by plating from one bath to another in like processes versus using dielectric materials in magnetic core 12.

Further, depending on desired design parameters, magnetic core 12 may be of a closed nature or, alternatively, a small gap 42 may be provided in magnetic core 12 by changing a mask layer. The gap enables higher levels of energy to be stored in magnetic core 12 thereby expanding the number of applications for the magnetic device.

FIG. 4A depicts a top view of partially completed device 10 after completion of stage 2. FIG. 4B depicts a top view of partially completed device 10 incorporating the gap 42 after completion of stage 2. FIG. 5A depicts a cross-sectional view of partially completed device after completion of stage 2 wherein magnetic core 12 comprises a single layer of magnetic core material 38; silicon dioxide layer 30, insulating layer 32, lower conductor 20, dielectric layer 34, insulating layer 36, and single magnetic core material 38 layer are depicted. FIG. 5B depicts a cross-sectional view of partially completed device 10 after completion of stage 2 wherein magnetic core 12 comprises a plurality of magnetic core material 38 layers separated by dielectric layers 40; silicon dioxide layer 30, insulating layer 32, lower conductor 20, dielectric layer 34, insulating layer 36, plurality of magnetic core material 38 layers, and plurality of dielectric layers 40 are depicted.

I.C. Stage 3: Establishment of Vias

To establish vias 24, with reference to FIGS. 6 and 7, a dielectric layer 42 is first deposited over magnetic core 12 to provide isolation between magnetic core 12 and upper conductor 22. Dielectric layer 42 is preferably a polymer or silicon dioxide; however, other dielectrics may be used without departing from the spirit or scope of the invention. A thin aluminum hard mask is then preferably applied over dielectric layer 42. Next, a photoresist material is applied over the aluminum hard mask, and conducting vias 24 (holes) are defined using a via mask. The thin aluminum hard mask is then preferably etched to expose insulating layers 32 and 36 at the position of conducting vias 24.

Next, conducting vias 24 are preferably dry etched to remove insulating layers 32 and 36 down to lower conductor 20. Conducting material 44, preferably the same material as used for lower conductor 20 and upper conductor 22, is then electroplated or sputter deposited within vias 24. The photoresist layer is then etched, or otherwise dissolved. And, finally, the thin aluminum hard mask is etched from the surface in preparation for deposition of upper conductor 22.

FIG. 6 depicts a top view of partially completed device 10 after completion of stage 3. FIG. 7 depicts a cross-sectional view of partially completed device 10 after completion of stage 3; silicon dioxide layer 30, insulating layer 32, lower conductor 20, dielectric layer 34, insulating layer 36, magnetic core 12, dielectric layer 42, and vias 24 filled with conducting material 44 are depicted.

I.D. Stage 4: Addition of Upper Conductor

The fabrication processes and sequences used in forming the lower conductor are now repeated to form the upper conductor. The thickness of the lower and upper conductor is a predetermined value which takes into account the resistance of the conducting material, as is described in further detail in Section II below.

In the case of the electroplating process for formation of the conductors and magnetic layer, a mask is applied which covers the active part of the device and the area outside the mask is etched away to remove undesired portions of the remaining seed layer. Device 10, now substantially complete, is then encapsulated or otherwise protected, with a non-conductive dielectric material 46.

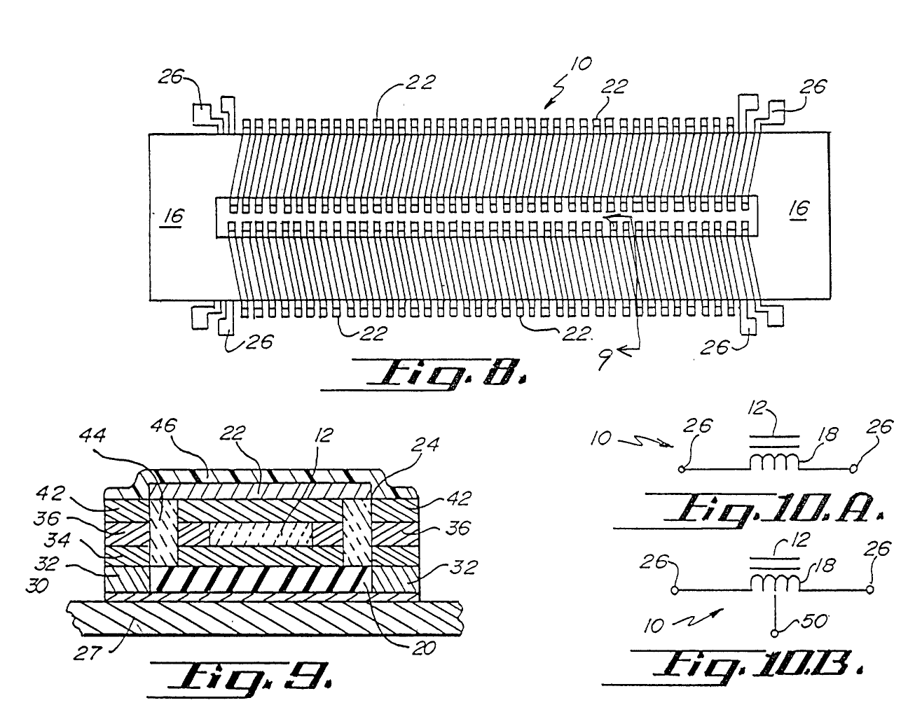

FIG. 8 depicts a top view of the now complete device 10, as it appears after completion of stage 4. FIG. 9 depicts a cross-sectional view of the now complete device 10, as it appears after completion of stage 4; silicon dioxide layer 30, insulating layer 32, lower conductor 20, dielectric layer 34, insulating layer 36, magnetic core 12, dielectric layer 42, vias 24 filled with conducting material 44, upper conductor 22, and dielectric material 46 encapsulation are depicted. Layer 46 can also encapsulate layers 42, 36, 32 and part of substrate 27.

It should be noted that variations on the above process, such as variations in planarization techniques, mask techniques, and deposition techniques, may be used without departing from the spirit or scope of the invention.

Further, the above describes a preferred manner of construction of device 10 wherein the bottom part of coil winding 18, i.e., lower conductor 20, is formed on the substrate, a magnetic core 12 is deposited over the lower conductor, and the top part of coil winding 18, i.e., upper conductor 22, is deposited over magnetic core 12 with vias 24 connecting upper and lower conductors 20, 22.

A different method of construction for an ultra-miniature device generally comprises the following steps. First, the base of the magnetic core is deposited on the substrate. Next, the coil windings are deposited on the base in a spiral fashion. Then, additional core material is deposited around the outside and in the center of the coil spiral to a height greater than the coil windings. Device 10 is then completed by depositing magnetic material over the top to complete the magnetic path. While this manner of construction of device 10 is feasible, it has undesirable restrictions including limits on the number of coil turns per unit area, difficulty in forming thick core structures, and the need to bring the inner ends of the coil to the outside. These restrictions are generally not found in the preferred method of construction.

Further, it should be noted that different patterns of the photomasks used for the various steps will yield different device features and performance characteristics. For example, by changing the placement of vias 24, the arrangement of lower and upper conductor 20, 22 paths, and the location of bonding pads 26, a designer has the ability to fabricate a single coil inductor having simple windings, multiple windings, or multiple connection taps. Further variations readily result in creation of a transformer having two or more windings, each of simple, bifilar, or multifilar configurations. The ratio of turns for each coil created can further be adapted to suit particular circuit requirements. Further, the sizes, spacing, and proximity of windings 18 to magnetic core 12 may be adapted for specific needs. Different magnetic core materials, conductor film materials, dielectric materials, processes, and sizes similarly yield variations in performance.

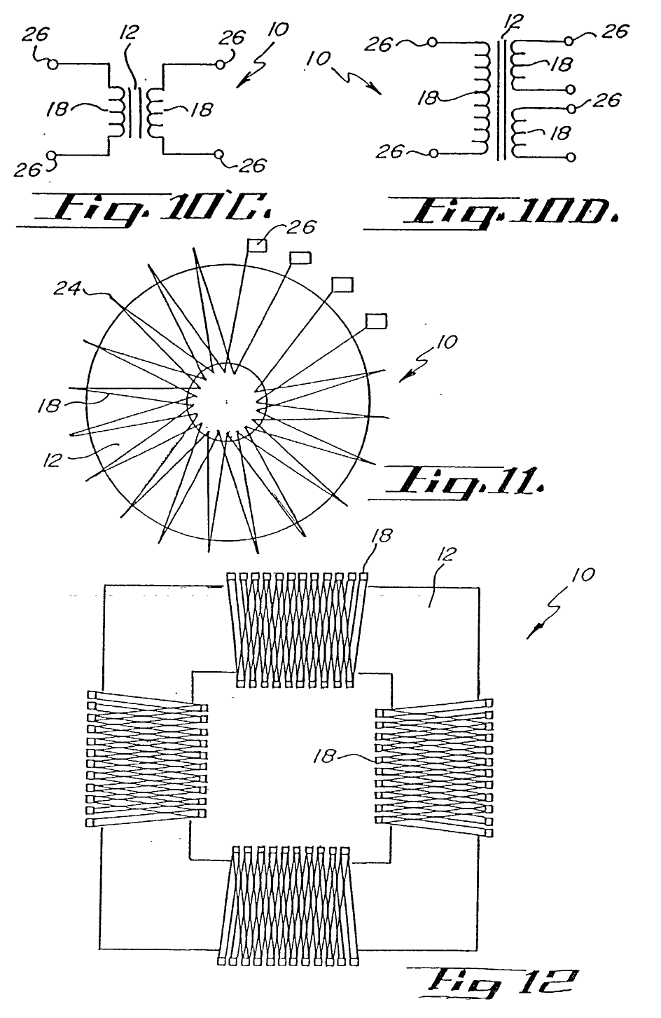

FIGS. 10A-D depicts a small sampling of the variations utilizing device 10. These variations include, but are not limited to, an inductor (10A), an inductor with a center-tap 50 (10B), a transformer (10C), and a transformer with a single primary coil and two secondary coils (10D).

II. Design Considerations for Ultra-Miniature Magnetic Device

In conventional inductor/transformer design, the designer is usually limited to selecting standard catalog core sizes and wire gauges. Deviation from standard core sizes and wire gauges usually results in high tooling costs, which can only be offset by large volumes. However, with the present device 10, these standard restrictions do not apply and the designer is provided with many design options and considerations which can be and preferably should be addressed prior to fabrication of device 10 for a specific application. Some of these design considerations were discussed in section I above. Additional considerations to those above include a desire to produce device 10 with a high permeability, with a reduction of parasitic effects, and with a minimization of core losses; each of these considerations is discussed in detail below. After the design considerations discussion an example transformer design is provided.

II.A Producing the Device with a High Permeability

Generally, it is desirable to produce device 10 with the highest permeability (or inductance) that is reasonably achievable for the application in which device 10 is placed. A main factor in determining inductance is the size and shape of magnetic core 12 and the permeability of the magnetic material. Equation 1 represents the initial permeability, μi, of a magnetic core:

$$μ i = \frac{L}{4 π * {N}^{2}} * \frac{lm * {10}^{9}}{Ac} \qquad Eq . ( 1 )$$

where: L is the inductance in Henries;

N is the number of turns in the coil about the core;

lm is the magnetic path length in centimeters; and

Ac is the core cross-section area in square centimeters.

From Equation 1 it can be seen that both the core cross-section area (Ac) and the magnetic path length (lm), i.e., core size and shape, are key factors in increasing or decreasing the inductance of device 10. The number of turns in the coil about the core is also important.

Referring to FIG. 11, a circular configuration of device 10 is depicted. This configuration is modeled after traditional toroidal inductors. However, as can be seen the number of turns, N, per unit area is quite small. Thus, inductance per unit area is generally lower than desired. Further, with reference to fabrication considerations, screens for electroplating are very complex. Thus, while the circular configuration is feasible, it does not provide the designer with optimal inductance or permeability or design options.

Referring to FIG. 12, a square configuration of device 10 is depicted. This configuration is an adaptation of a toroid having four straight sides. This design has a higher density of turns than the circular configuration of FIG. 10 and all four sides can be connected together to yield a higher inductance. However, the drawback of this design is that the turns, N, per unit area is still fairly small and the resulting transformer is generally physically larger than desired for high frequency applications. Further, with reference to fabrication considerations, screens for electroplating are very complex. Thus, while the square configuration is also feasible, it does not provide the designer with optimal inductance or permeability or design options.

Referring to FIG. 13, an octagonal configuration of device 10 is depicted. This configuration enables an increase in the number of turns, however, the physical size of device 10 grows rapidly and the resulting inductance per unit area is low. Further, with reference to fabrication considerations, screens for electroplating are very complex. Thus, while the octagonal configuration is also feasible it does not provide the designer with optimal permeability or design options.

Referring to FIG. 14, an oval configuration of device 10 is depicted. This oval configuration and the rectangular configuration of FIG. 1 are the preferred configurations and provide advantages that the other configurations do not provide. Specifically, with respect to permeability, the elongate shape allows an inductor/transformer to be fabricated with windings 18 distributed on either side of magnetic core 12. Thus, coil windings 18 may be of a larger cross-section and, therefore, of a lower resistance.

Additional advantages, beyond the high permeability advantage, is that the elongate designs provide for a straight forward layout wherein both elongate sides and short sides may be lengthened or shortened as desired. Further, these designs may be scaled up or down in the X-Y plane to meet the demands of operational frequency and physical constraints. The elongate shape affords more space for the placement of the internal segments of conductors 20, 22. This translates to lower process precision requirements, lower production costs and greater reliability.

Additionally, these elongate configurations can be fabricated easily by several methods, including thin or thick film procedures, electroplating, vacuum deposition and etching processes (including PECVD, RF sputter deposition, reactive ion etching, ion milling, plasma etching, photo-lithographic processes, and wet chemical etching). Further, these elongate configurations allow for orientation of the easy magnetic axis in the direction of magnetic core 12 (see FIG. 15A), at 90° to the direction of the core (see FIG. 15B), or at any angle with respect to the direction of magnetic core 12 by subjecting magnetic core 12 to an external magnetic field 52. Thus, satisfying different core saturation requirements (e.g., energy storage vs. maximum inductance). Moreover, with these elongate configurations, layering of magnetic core 12 with thin dielectric interlayers to reduce core losses is also an easily obtained option. As well, the elongate rectangular or oval configurations yield an optimum magnetic path length and allow a repeatable straight-line path for coil winding.

Referring to FIGS. 15C and 15D, in an alternate embodiment a magnetic core arrangement 130 has an easy axis of magnetization in its entire body and is formed about a central aperture over a substrate. In an example process for making the magnetic core arrangement, a metallic seed layer (optional), such as a Ti/Cu/Ti layer, is formed on substrate 27 before masking a portion of substrate 27 with a first photoresist mask 150. Mask 150 serves as a photoresist mold for forming a first set of plated magnetic material layers (e.g., elongate sections 131A and 131B) of the magnetic core arrangement on substrate 27 and the seed layer. Substrate 27 with mask 150 is then placed in a plating bath 170 to form plated magnetic material layers 131A and 131B of magnetic core arrangement 130 (FIG. 15C). In this example embodiment, plating bath 170 is an electroplating bath of nickel-iron for forming elongate sections 131A and 131B. While substrate 27 is being plated, the substrate and mask 150 are subjected to an external magnetic field 53 to align an easy axis of elongate sections 131A and 131B of magnetic core 130 along a desired direction relative to the unmasked portion of magnetic core arrangement 130. Substrate 27 with the plated portions or sections is then removed from bath 170 and first photoresist mask 150 is then removed from substrate 27, thereby leaving only elongate sections 131A and 131B spaced from each other (see FIG. 15C).

A second photoresist mask 152 is then formed over elongate sections 131A and 131B and over other portions of substrate 27. In this example process, mask 152 serves as a photoresist mold for forming the short sections of a substantially rectangular magnetic core 130. Substrate 27 with mask 152 is then rotated about 90 degrees and placed in plating bath 170 to form a second set of plated magnetic material layers (e.g., short sections 131C and 131D), as illustrated in FIG. 15D. While the second set of plated layers are being formed, substrate 27 is subjected to external magnetic field 53 to align an easy axis of the second set of magnetic layers (parallel with the long axis of the magnetic layers). In a related embodiment, the substrate need not be turned 90 degrees where the external magnetic field is in a different direction from that shown in FIGS. 15C-15D. Second photoresist mask 152 is then removed, resulting in the formation of magnetic core arrangement 130 from sections 131A/B and 131C/D having a central aperture 131E. Core arrangement 130 has an easy axis of magnetization along both sections of the magnetic core thereby increasing the efficiency of the core. Core arrangement 130 is not necessarily limited to a rectangular or square configuration and can include oblong, U-shaped or toroidal shaped magnetic cores.

In one example embodiment, a single layer magnetic core has a thickness of less than about 10 microns (preferably about 5 microns in thickness) and has an easy axis of magnetization about the entire layer.

In a related embodiment, FIG. 15E illustrates plated layers (or sections) 131A′ and 131B′ and 131C′ and 131D′ being formed with angles (about 45 degrees) at each end to facilitate the joining of the sections to form the magnetic core or to form one magnetic layer of a multiple layer magnetic core. The easy axis of magnetization is indicated as 131E.

An advantage to having an easy axis about the entire core is that a hard axis is not present that will impede the magnetic path in a magnetic core layer. In a related embodiment, the full 360-degree easy axis functionality is applicable to multiple layer magnetic cores that utilize either dielectric materials or non-magnetic metallic materials (e.g., copper, gold, silver and aluminum) to reduce eddy current effects within the magnetic core. In one example embodiment, a magnetic device includes alternating magnetic material layers with interleaving non-magnetic material layers, wherein each magnetic material layer is treated to include an easy axis of magnetization around the entire layer before the succeeding non-magnetic material layer is formed. In one example, after forming each magnetic layer in a plating bath, the substrate with the magnetic layer is placed in a copper-plating bath to form the interleaving layer. This copper layer is about one-hundredth the thickness of the magnetic material layer (or about 1% of the thickness of the magnetic layer). A magnetic material layer is then deposited on the copper layer.

In related embodiments, the non-magnetic layer has a thickness of about 1% of the thickness of the magnetic layer, and can include such materials as gold, silver, and aluminum. In yet another embodiment, the non-magnetic material includes a dielectric material.

The process of forming alternating magnetic material layers with easy axes with alternating copper layers is repeated several times until the desired thickness of the core is reached for each of the short and long sections or legs, independently. Due to the height differential between the magnetic device and active components and the incompatibility of manufacturing processes of the two, magnetic devices and active components are usually not formed on the same substrate.

In the various embodiments described the magnetic core arrangements include a central aperture to facilitate single and dual windings to be formed about the various sections of the magnetic core. With respect to the multiple layer core arrangement, the easy axis masking steps are performed on each alternating magnetic core material layer. Such a magnetic device has high permeability (increases the inductance of the coil members) due to reduced core losses (little or no eddy currents) and does not have a significant (or any) hard axis on any of the magnetic material layers to impede the path of the magnetic fields within the magnetic core arrangement of the magnetic device.

In designing the preferred elongate-shaped configurations of device 10, the following should also be kept in mind with reference to Equation 1 above and Equation 2 below. First, it should be noted that increasing the thickness of magnetic core 12 also increases its cross-sectional area. A 10× increase in cross sectional area, Ac, results in a 10× increase in inductance. However, an increase in thickness of magnetic core 12 only results in a small increase in coil winding DC resistance. In addition, as the area of magnetic core 12 increases, the flux level of device 10 decreases, see Equation 2 for magnetic flux density, β

$$β = \frac{E * {10}^{8}}{4.0 * Ac * F * N} \qquad Eq . ( 2 )$$

where: E is the drive voltage applied to device 10, e.g. 5 v;

4.0 is a constant for a square wave;

Ac is the cross-sectional area of the magnetic core;

F is the primary operating frequency, e.g. 10 MHz; and

N is the number of turns in the coil winding.

Thus, in Equation 2, increasing Ac by 2× decreases the flux density by 2×. Since the maximum flux density is a fixed quantity for any core material, the low frequency cut-off is lowered for any increase in core cross-sectional area. Increasing the cross-sectional area permits an increase in the drive voltage, E, applied to the device, however, breakdown of the dielectric material imposes a practical limit to the drive voltage.

Further, with reference to the magnetic core material and permeability, as indicated in section I above, the preferred core material is an iron/nickel/cobalt composition (15/65/20%). This material is chosen because it has high nickel content and, therefore, a high permeability. Further, the saturation level of the material can sustain high levels of flux density and a small number of turns can achieve the desired inductance.

II.B. Reduction of Parasitic Effects

In using device 10 as a transformer, parasitic effects are of concern. As such, with reference to the transformer model of FIG. 16, these parasitic effects and methods to reduce them so as to extend the operation of device 10 in the high frequency range are discussed below.

The first parasitic effect of concern with reference to FIG. 16 is the distributed capacitance, Cd. The distributed capacitance, Cd, operates to limit the upper bandwidth of device 10, an undesired effect. However, by using a high permeability material, such as the preferred iron/nickel/cobalt composition (15/65/20%), the distributed capacitance can be kept to a minimum by using fewer turns to attain the same inductance.

The second parasitic effect of concern with reference to FIG. 16 is leakage inductance. It is preferable to keep leakage inductance to a minimum. This may be accomplished by winding primary and secondary coils closely to each other, i.e. bifilar winding. The result of this is an increase in the coupling coefficient (the coupling of the magnetic lines of flux between the primary and secondary winding), which operates to reduce leakage inductance.

A third parasitic effect of concern is the DC resistance (Rpri and Rsec) of the coil windings 18. As mentioned earlier, a large number of coil turns yields a high inductance. However, too many turns increase the DC resistance to a generally unacceptable level. Additional coil turns also cause an increase in distributed capacitance, Cd, of device 10 as described earlier. Reduction of the DC resistance can be achieved by increasing the thickness and the width of upper and lower conductors 20, 22. Another method of reducing DC resistance is to use lower resistivity conductor material such as copper, silver or gold.

The above factors are also considerations in the fabrication of inductors.

II.C. Core Losses

Core losses of the magnetic core material are yet another design factor to consider prior to fabrication of device 10 for a specific application. Note however, that core losses are not an overly significant factor if device 10 is to be used in communication applications. If device 10 is to be used in non-communication applications, the designer should be aware that there are parasitic effects that result from core material losses. One of these parasitic effects is dimensional resonance. Dimensional resonance is a result of eddy currents in an axis perpendicular to the desired magnetic flow. By reducing the permeability of the core material in the vertical axis but maintaining high permeability in the horizontal axis, the core losses are minimized. This is accomplished by separating multiple layers of magnetic core material, e.g., iron/nickel/cobalt composition (15/65/20%), by thin layers of dielectric material. Layering in this fashion significantly reduces eddy current losses.

Another reason to maintain a high permeability core relates to low frequency cut-off of the transformer. In order to reduce the low frequency cut-off point, the open circuit inductance must be increased. Referring to FIG. 16, the open circuit inductance (Loc), is in parallel with the load. As operating frequency decreases, the reactance of Loc decreases and limits the amount of signal or power transferred to the load. It is therefore desirable to maintain a high inductance, which necessitates a high permeability core.

II.D. Example Transformer Design

The following transformer example is provided as an illustration of one use of device 10 and is not to be taken as limitation on the broader invention of the ultra-miniature magnetic device which is suitable for many applications beyond that of a transformer.

In view of the above design considerations, an ultra-miniature magnetic device 10 may be specified to substantially equivocate the operation of an Ethernet transformer, specifically a transformer used in a common Access Unit Interface (AUI). An AUI is present on many Ethernet network interface cards, thus allowing backward compatibility. Each of the AUI's generally contain three 1:1 turns ratio transformers that operate at a primary frequency of 10 MHz and have additional high frequency components. An optimal Ethernet transformer has a desired coupling coefficient of 1.0 for a fast rise time signal. With the present device 10 operating as a transformer, this requires a very low leakage inductance and a minimal distributed capacitance.

As such, using device 10, N, the number of turns in coil winding 18 is chosen to be 20 turns for both primary and secondary coils. The size of conductors is preferably 5 μm thick by 50 μm wide. To minimize leakage inductance, the primary and secondary coils are bifilar (adjacent to each other). Magnetic core 12 width of 0.5 mm is preferably based on a desired device length limit of approximately 5 mm. Core thickness is preferably 5 μm. Upper and lower conductors 20, 22 are preferably of copper.

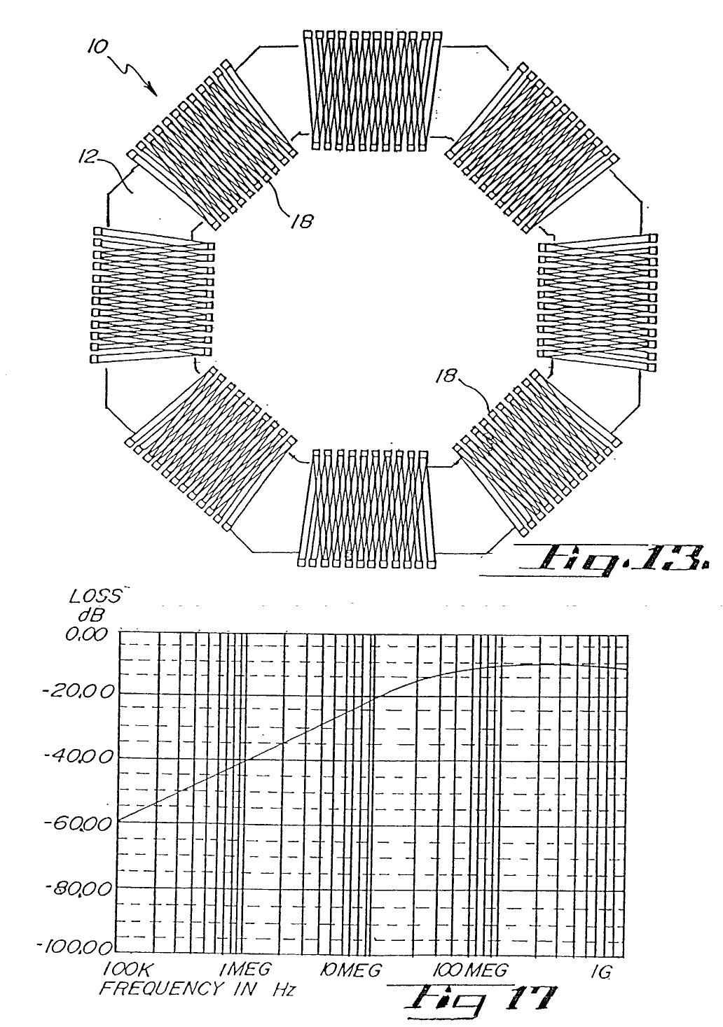

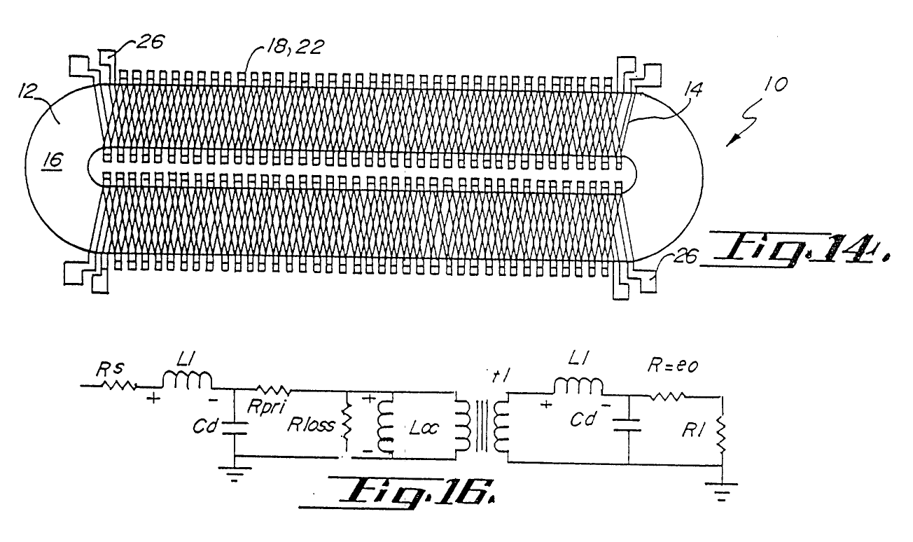

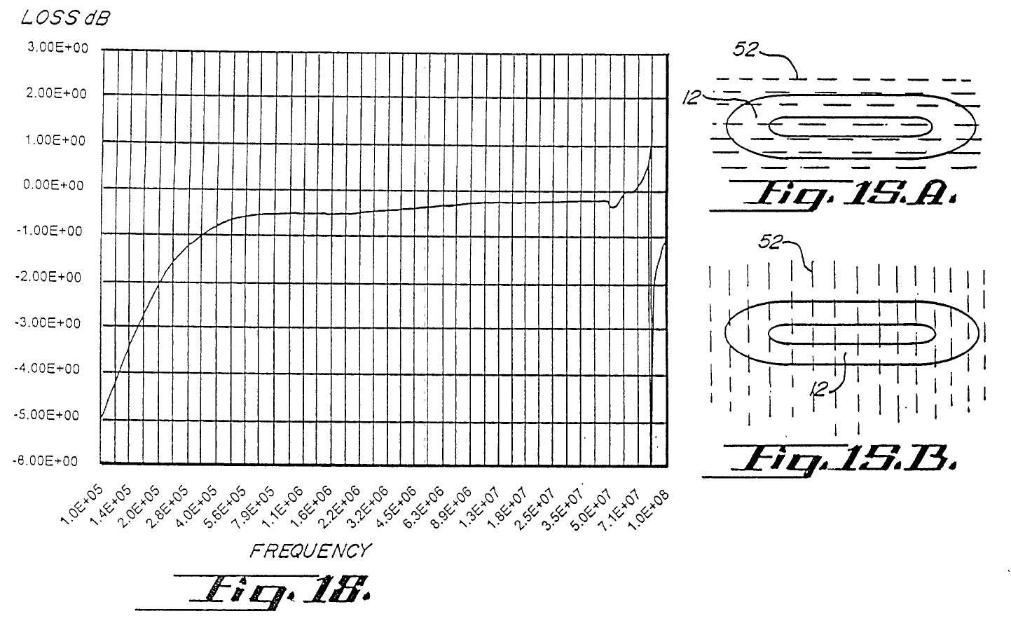

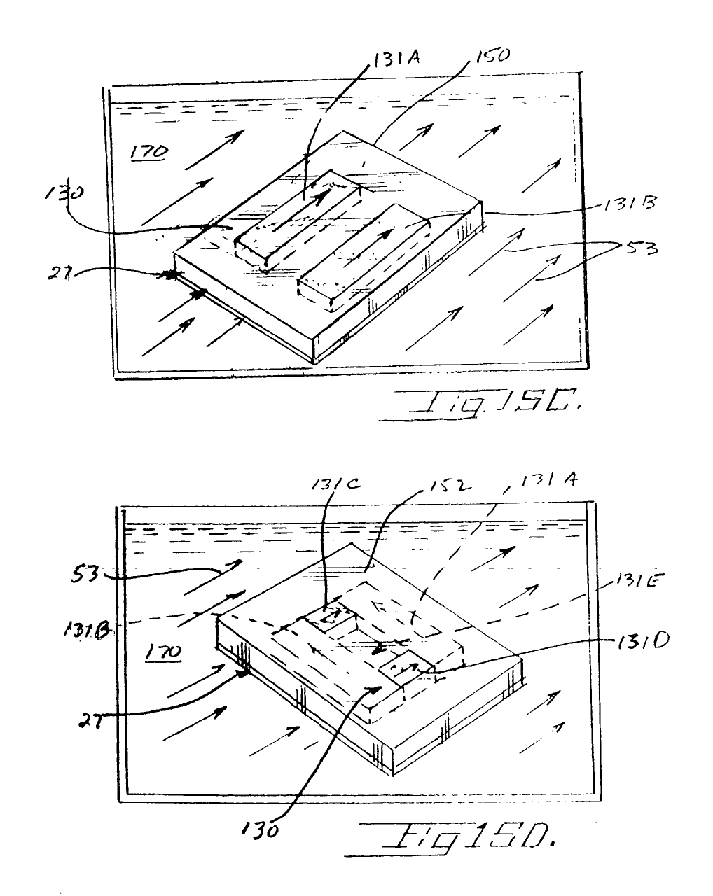

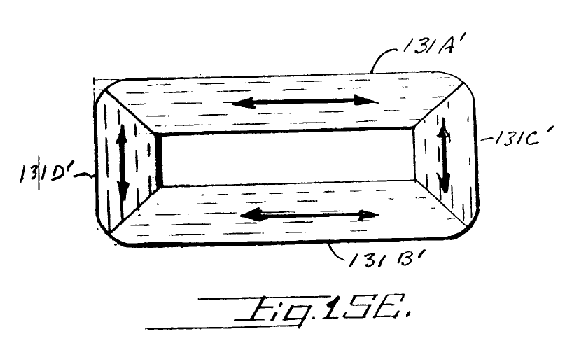

The response of a transformer fabricated using the elongate configuration of device 10 is expected to approximate the loss vs. frequency plot of FIG. 17. In comparing the plot of FIG. 17 with the plot of an actual Ethernet transformer, see FIG. 18, it can be seen that the designed transformer comparatively matches to the Ethernet transformer currently on the market.

III. Applications of Ultra-Miniature Magnetic Device

As described above, device 10 is preferably fabricated using traditional semiconductor technology and is therefore, suitable for automated production. This provides greater consistency, and hence greater quality control, and reduces manufacturing costs. As such, device 10 is suitable for many inductor/transformer applications including but not limited to computer data transmission, cable TV video and interactive CATV and video circuitry, DC-DC converters, filters, miniature magnetic power devices, Ethernet network transformers, and other applications involving high frequency signals. Device 10 is also suitable for lower frequency applications such as in telephone line T1/E1 products, 64 KHz or 128 KHz ISDN lines and modem devices.

Device 10 can be readily adapted to provide a wide variety of electrical connections to suit the needs of various applications. Variations in the choice of methods of fabrication as well as choice of materials and sizes for magnetic core 12, conductors 20, 22 and dielectric layers yield predictably different electrical performance characteristics.

The present invention may be embodied in other specific forms without departing from the essential attributes thereof; therefore, the illustrated embodiments should be considered in all respects as illustrative and not restrictive, reference being made to the appended claims rather than to the foregoing description to indicate the scope of the invention.

What is claimed:

1. A method for fabricating a magnetic core, comprising the steps of:
patterning a first photoresist layer disposed over a substrate, therein exposing at least a first portion of the substrate;
plating the at least first exposed portion of the substrate with a magnetic material while subjecting the substrate to an external magnetic field so as to form a first magnetic material layer over the substrate, wherein the magnetic field aligns an easy axis of magnetization in a direction parallel to a long axis of the first magnetic material layer;
removing the first photoresist mask and forming a second photoresist mask to cover the first magnetic material layer and expose at least a second portion of the substrate;
plating the at least second exposed portion of the substrate with a second magnetic material while subjecting the substrate to the external magnetic field so as to form a second magnetic material layer over the substrate and adjacent the first magnetic material layer, wherein the magnetic field aligns an easy axis of magnetization in a direction parallel to a long axis of the second magnetic material layer; and
removing the second photoresist mask and exposing the magnetic core formed from the first and second magnetic material layers, wherein the magnetic core has an easy axis of magnetization that extends to parallel to the long axis of first and second magnetic material layers.

2. A method for fabricating a magnetic core, comprising the steps of:
a) forming a first photoresist layer over a substrate that includes at least two portions that expose the substrate;
b) plating the at least two exposed portions with a magnetic material while subjecting the plated material to an external magnetic field so as to form a first set of magnetic material layers, wherein the magnetic field aligns an easy axis of magnetization in a direction parallel to a long axis of the first set of magnetic material layers;
c) removing the first photoresist mask and forming a second photoresist layer that masks the first set of magnetic layers and that includes at least two portions that expose the substrate;
d) plating the at least two exposed portions with a magnetic material while subjecting the plated material to the external magnetic field so as to form a second set of magnetic material layers, wherein the magnetic field aligns an easy axis of magnetization in a direction parallel to a long axis of the second set of magnetic material layers; and
e) removing the second photoresist layer and exposing the magnetic core formed from the first and second set of magnetic material layers surrounding a central aperture, wherein the magnetic core has an easy axis of magnetization which extends parallel to the long axis of the magnetic material layers.

3. The method of claim 2, wherein each of steps b) and d) further comprise:
forming a dielectric layer over the magnetic material layers; and
plating over the dielectric layer with a magnetic material.

4. The method of claim 3, further comprising repeating steps a) through e) until the magnetic core reaches a predetermined thickness.

5. The method of claim 2, wherein each of steps b) and d) further comprise:
forming a non-magnetic metallic layer over the magnetic material layers; and
plating over the non-magnetic metallic layer with a magnetic material.

6. The method of claim 5, further comprising repeating steps a) through e) until the magnetic core reaches a predetermined thickness.

7. The method of claim 2, wherein the steps of plating with the magnetic material includes incorporating an air gap into the layer of the magnetic material.

8. The method of claim 5, wherein the non-magnetic metallic layer includes copper having a thickness of about one-hundredth of the thickness of the magnetic material layer.

9. The method of claim 2, wherein the forming the first set of magnetic layers includes forming at least two elongate sections separated by the central aperture and forming the second set of magnetic layers includes forming at least two short sections separated by the central aperture;

10. The method of claim 9, wherein the magnetic core is formed in an oblong shape having angled portions where the elements and short sections are joined.

11. The method of claim 2, wherein the magnetic core is formed into an oblong or U-shape.

12. A magnetic device comprising:
a magnetic core arrangement that includes a central aperture and is comprised of at least one layer of a non-magnetic metallic material interleaved between at least two magnetic material layers, wherein the magnetic material layers substantially surround the central aperture and are adapted to include an easy axis of magnetization about the entire layer; and
a conductive winding substantially encircling at least one side of the magnetic core arrangement, wherein the non-magnetic material layer is adapted to reduce the eddy currents within the magnetic material layers and to increase the inductance of the device by increasing a thickness of the magnetic core arrangement.

13. The magnetic device of claim 12, further comprising alternating layers of the magnetic material layer and the non-magnetic metallic material layer until a predetermined thickness is reached.

14. The magnetic device of claim 13, wherein the non-magnetic material includes copper.

15. The magnetic device of claim 13, wherein the non-magnetic material is selected from the group consisting of gold, silver and aluminum.

16. The magnetic device of claim 14, wherein the copper layer is about one-hundredth the thickness of the magnetic material layer.

17. The magnetic device of claim 12, wherein the magnetic material layers of the magnetic core arrangement includes at least two elongate sides separated by the central aperture and at least two short sides separated by the central aperture.

18. The magnetic device of claim 12, wherein said magnetic core arrangement has a cross-sectional area and is adapted to be scaled to suit a specific magnetic device application.

19. The magnetic device of claim 12, wherein said magnetic core arrangement includes an air gap.

20. The magnetic device of claim 12, wherein said conductive winding comprises a winding selected from a group consisting of:
a simple winding, a bifilar winding, and a multifilar winding.

21. A magnetic device comprising:
a magnetic core arrangement comprised of a magnetic layer surrounding a central aperture and having a thickness under 10 microns, the magnetic material layer adapted to include an easy axis of magnetization about the entire layer; and
a conductive winding substantially encircling at least one side of the magnetic core arrangement.

22. The magnetic device of claim 21, wherein the magnetic material layer includes at least two elongate sides separated by the central aperture and at least two short sides separated by the central aperture.

23. The magnetic device of claim 12, wherein the non-magnetic material includes a dielectric material.

24. The magnetic device of claim 21, wherein said conductive winding comprises a winding selected from a group consisting of:
a simple winding, a bifilar winding, and a multifilar winding.
